(19) United States
(12) Patent Application Publication
(10) Pub. No.: US 2018/0164036 A1
(43) Pub. Date: Jun. 14, 2018

(54) COLD CRUCIBLE INSERT

(71) Applicant: Fluxtrol Inc., Auburn Hills, MI (US)

(72) Inventor: Valentin Nemkov, White Lake, MI (US)

(73) Assignee: Fluxtrol Inc.

(21) Appl. No.: 15/837,542

(22) Filed: Dec. 11, 2017

Related U.S. Application Data
(60) Provisional application No. 62/433,086, filed on Dec. 12, 2016.

(51) Int. Cl. F27B 14/10; B22D 41/60; B22D 17/10

(52) U.S. Cl. CPC F27B 14/10; B22D 41/60; F27B 2014/0862; F27B 2014/108; B22D 17/10

(57) ABSTRACT

A cold crucible may include a plurality of fingers extending in an axial direction and arranged in a circumferential direction, and a slit between each pair of adjacent fingers. The cold crucible may also include at least one insert in each of the slits. The at least one insert may include a first component made of a soft magnetic composite material, and a second component made of a soft magnetic component.

### CROSS-REFERENCE TO RELATED APPLICATIONS

This application claims priority to U.S. Provisional Patent Application No. 62/433/086, filed on Dec. 12, 2016, the contents of which are incorporated herein by reference in their entirety.

### BACKGROUND

Cold crucible furnaces may be used for high temperature melting of metals and other materials under controlled environmental conditions. Such furnaces are often used for melting highly reactive metals (e.g., zirconium or titanium and their alloys) or for the production of very high purity materials.

In one illustration, an induction cold crucible furnace is formed from a copper compound and using a fluid-cooling mechanism including a fluid-cooling channel typically located adjacent a base portion of the crucible. At an inner internal diameter of a wall of such a crucible there are significant concentrations of electrical losses, heat transfer from the high temperature melt and the copper compound making up the crucible is located the greatest distance from the water-cooling channel.

In practice, to allow penetration of the magnetic fields of induction through the crucible, thin axial slits are typically made in the crucible wall. Thus, by using such slits, the crucible wall is broken up into a set of fingers. Current is induced around each finger and the slits are in place to allow penetration of the magnetic field through the crucible. There are two main current components in the fingers, a first current portion induced by the axial magnetic field in the cold crucible furnace that flows around the fingers, and a second current portion induced by the radial magnetic field in end zones of the cold crucible that flows along the fingers closing at their ends.

Additionally, copper end caps are often placed on the crucible fingers. Sometimes they are in place for the purpose of containing the melt, and can be split to reduce losses. They are often used for shielding purposes.

Helpfully, a significant part of the melt has no direct contact with the crucible due to electrodynamic forces confining the melt. The materials in contact with the cold crucible form a solid layer—a skull, which prevents the contact of the resulting liquid with the copper compound of the crucible and reduces thermal losses from the melt.

Nevertheless, cold crucible furnaces have a number of drawbacks including low electrical efficiency and limited thermal efficiency despite the presence of the skull and fluid-cooling mechanism. In particular, the crucible fingers are a major source of electrical losses in cold crucible furnaces as are the copper end caps, which may act as Faraday rings.

Providing correctly placed magnetic inserts in the slits has recently been shown to reduce the axial current in the finger, and therefore improving both electrical and thermal efficiency in the fingers, as detailed in the papers “Modeling and Optimization of Cold Crucible Furnaces for Melting Metals” (2013) by V. Nemkov et al., and “Recent Design and Operational Developments of Cold Crucible Induction Furnaces for Reactive Metals Processing” (2013) by R. Haun et al., both of which are hereby incorporated by reference in their entirety.

However, such inserts are made of a soft magnetic composite material that do not readily withstand direct contact with the molten material or the high temperatures present on the internal diameter of the cold crucible, where there are significant concentrations of electrical losses, heat transfer from the high temperature melt and the copper is farthest from the water cooling channel as noted above. Therefore, the inserts need to be backed off slightly from the inner edge of the fingers and a ceramic grout is applied to the inside wall of the crucible and in the slits of the crucible to prevent melt leakage and direct contact between the melt and the combination of the high temperature compound forming the crucible and the insert material, which may lead to chemical attack of the insert, local arcing and contamination of the melt.

Accordingly, there is a need for an insert for a cold crucible that enables improved electrical and thermal efficiency for the cold crucible.

### BRIEF DESCRIPTION OF THE DRAWINGS

While the claims are not limited to the illustrated examples, an appreciation of various aspects is best gained through a discussion of various examples thereof. Referring now to the drawings, exemplary illustrations are shown in detail. Although the drawings represent representative examples, the drawings are not necessarily to scale and certain features may be exaggerated to better illustrate and explain an innovative aspect of an illustrative example. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1 is a schematic, cross-sectional view of a cold crucible furnace according to one exemplary approach;

FIG. 2 is a schematic, top cross-sectional view of the cold crucible furnace of FIG. 1;

FIGS. 3 and 4 are schematic diagrams of a desired magnetic path and a magnetic circuit, respectively, in a cold crucible furnace;

FIG. 5 is a schematic, top view of adjacent fingers of a cold crucible according to one exemplary approach;

FIGS. 6A-6D is a schematic, top view of adjacent fingers of a cold crucible according to alternative exemplary approaches; and

FIGS. 7 and 8 are graphs illustrating flux density and permeability, respectively, as functions of field strength of an exemplary first material.

### DETAILED DESCRIPTION

Reference in the specification to “one embodiment,” “an embodiment,” “an example,” or the like, means that a particular feature, structure, or characteristic described in connection with the embodiment is included in at least one exemplary illustration. The appearances of the phrase “in one example,” etc. in various places in the specification are not necessarily all referring to the same exemplary illustration.

Various exemplary illustrations are provided herein of composite inserts for cold crucibles. An exemplary insert may include a first component made of a soft magnetic composite material, and a second component made of a soft magnetic material. An exemplary cold crucible may include a plurality of fingers extending in an axial direction and arranged in a circumferential direction, and a slit between each pair of adjacent fingers. The cold crucible may also include at least one insert in each of the slits. The at least one insert may include a first component made of a soft magnetic composite material, and a second component made of a soft magnetic component.

An exemplary process for operating a cold crucible furnace may include supplying current through a coil wrapped around a cold crucible having a plurality of fingers extending in an axial direction and arranged in a circumferential direction. The process may then include generating a magnetic flux from the coil, which flows through the slits between the fingers of the cold crucible and interacts with a molten material (or charge) melted inside the crucible. The process may also include passing the magnetic flux through at least one insert inserted in slits between adjacent fingers to aid the magnetic flux to penetrate the fingers. The at least one insert may include a first component made of a soft magnetic composite material, and a second component made of a soft magnetic component material.

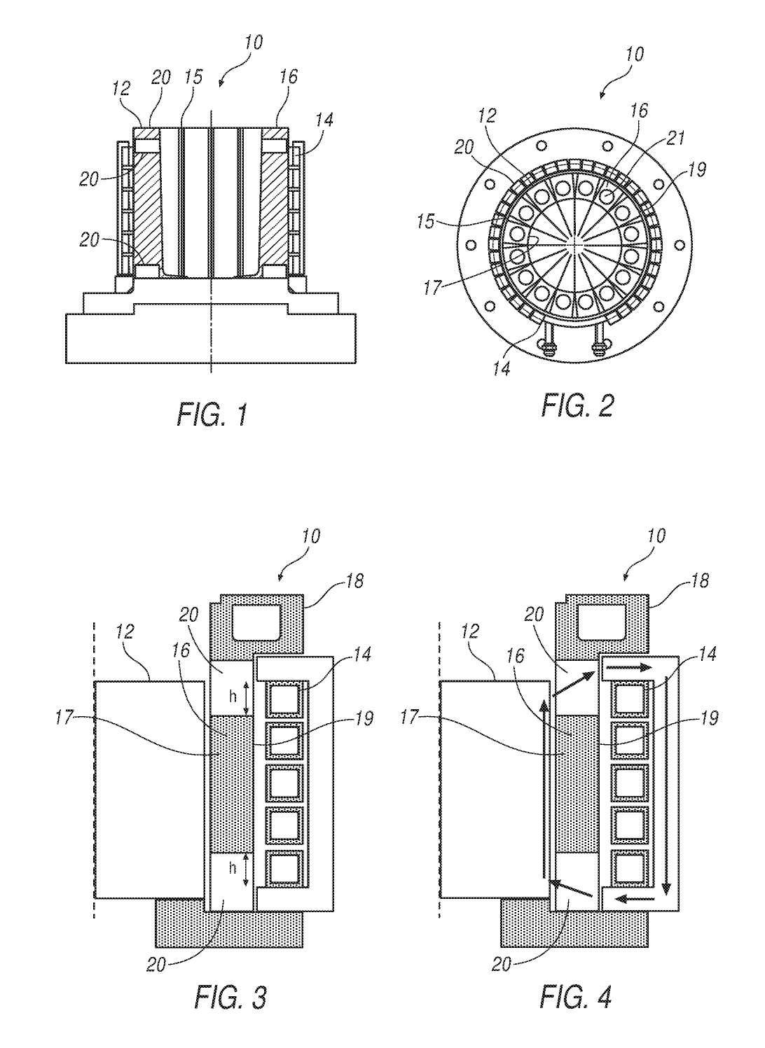

Turning now to the figures, FIGS. 1 and 2 illustrate an exemplary cold crucible furnace 10 used for melting highly reactive metals, such as zirconium and titanium, their alloys, or high purity materials, such as glass, via induction heating. The cold crucible furnace 10 may include a cold crucible 12, which generally may have a wall 13 defining an open cavity in which the materials (or charge) may be inserted and melted, and a coil 14 wound around the cold crucible 12 in a circumferential direction. When a current from a power source (not shown) is supplied through the coil 14, a magnetic field may be generated to flow through the wall 13 and around the coil 14, as illustrated in FIG. 4. While FIG. 4 illustrates the coil 14 as having six turns, it should be appreciated that there may be any number of turns depending upon various factors, including, but not limited to, the size of the coil 14 and the size of the cold crucible 12.

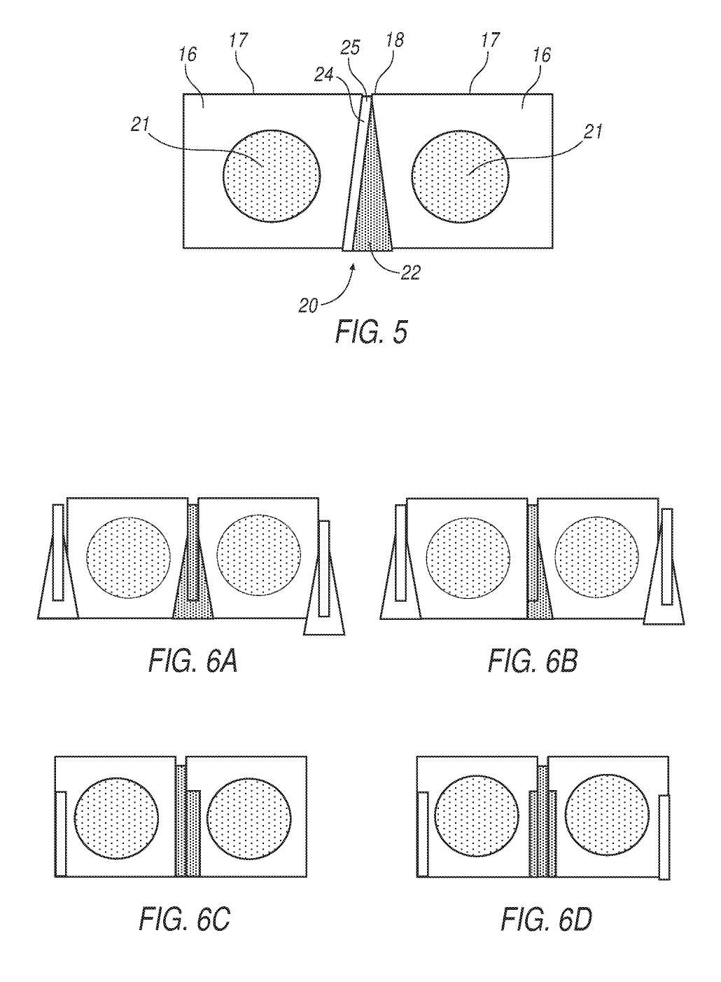

The wall 13 of the cold crucible 12 may be cylindrical in shape, and may have an inner diameter side 17 and an outer diameter side 19. The inner diameter side 17 may act as a melt surface when the materials are melted within the cold crucible 12. The wall 13 may have a plurality of circumferentially spaced slits 15 extending in an axial direction such that the wall 13 may be divided into a plurality of fingers 16 extending in the axial direction and positioned adjacent each other in the circumferential direction. The slits 15 may extend in a radial direction from the inner diameter side 17 of the wall 13 to the outer diameter side 19. The slits 15 may allow at least partial penetration of the magnetic flux through the wall 13, specifically, through the fingers 16, toward the melt surface. Each finger 16 may include water cooling 21 passing through it in the axial direction, as seen in FIG. 5. The cold crucible 12 may also include copper end caps 18 on the fingers 16. The copper end caps 18 may help contain the melt and/or shielding purposes, and may be split to reduce losses.

The cold crucible 12 may further include inserts 20 inserted into the slits 15 to help magnetic flux further penetrate through the fingers 16 toward the melt surface. Each insert 20 may extend from near the inner diameter end of the respective slit 15 to an outer diameter end such that the slit 15 is at least partially filled in the radial direction, and generally may have a similar cross-section as the slit 15. There is an optimal height of the inserts 20, as illustrated in FIG. 3. If the inserts are too small, they will not be able to carry enough magnetic flux. If the inserts are too large, they will bypass the magnetic flux rather than allowing the magnetic flux to penetrate the fingers 16 to the melt surface. The inserts 20 may be inserted at the tops and/or bottoms of the respective slits 15. In addition, all or only some of the slits 15 may include inserts 20 inserted therein.

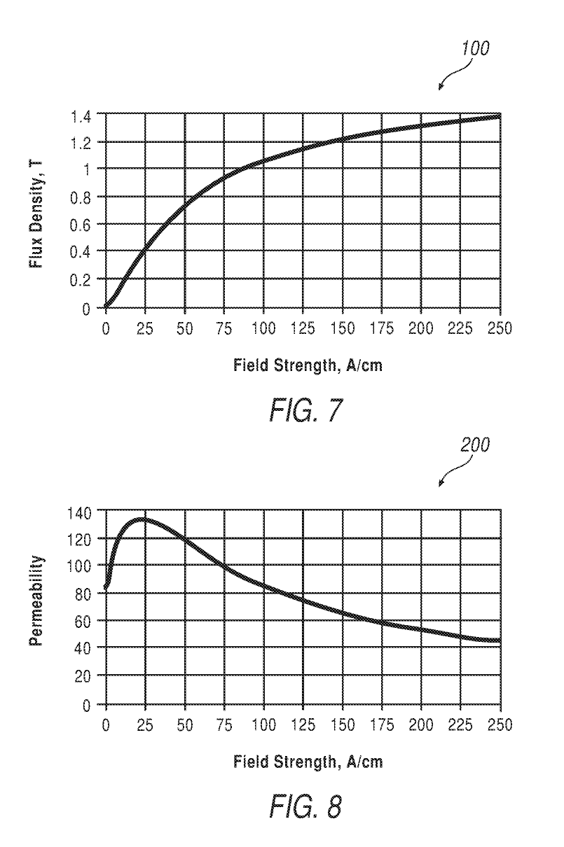

On the inner diameter side of the wall 13 of the cold crucible 12, the thickness of the slits 15 may be small to avoid melt leakage and increase magnetic forces to repel melt from ends of the inserts 20 at or near the inner diameter side of the slits 15, which can lead to chemical attack of the inserts 20, local arcing and contamination of the melt. As merely an example, the thickness of the slits 15, which may vary with the size of the cold crucible 12, may be around 3% of an inner diameter of the cold crucible 12. In one exemplary approach, the inner diameter side of the slits 15 may be thinner than the outer diameter side to form a wedged shape cross-section. The insert 20 may have a similar wedged shape cross-section. The small cross-section of the insert 20 at the inner diameter side of the slits 15 may lead to high magnetic flux density values, which in turn may reduce the ability of the insert 20 to support the magnetic field, i.e., lead to lower the magnetic permeability, as generally illustrated in the graphs 100 and 200 in FIGS. 7 and 8, respectively. Graph 100 illustrates flux density of a material of the inserts 20 as a function of magnetic field strength. Graph 200 illustrates relative magnetic permeability of the inserts 20 as a function of magnetic field strength. The relative permeability may be at or near its highest value (approximately 130 in graph 200) at a low flux density (approximately 0.35 T in graph 100). In comparison, at a high flux density, for example, approximately 1.4 T in graph 100, the relative permeability is much lower (approximately 45 in graph 200). Magnetic flux density generally may be determined by dividing magnetic flux by cross-sectional area. Thus, the additional cross-section of the inserts 20, with increasing distance from the inner diameter side of the slits 15, may serve to reduce the magnetic flux densities, thereby increasing the relative permeability of the inserts 20. The increased relative permeability may allow more flux to flow in a desirable direction and penetrate the fingers 16 to reach the melt surface or inner diameter side of wall 13, as illustrated in FIG. 4. Any flow outside of the path shown in FIG. 4 is generally undesirable.

The inserts 20 may include a first component 22 and a second component 24. The first component 22 may have a greater thickness than the second component 24, and may have a shape or profile generally corresponding to the shape or profile of the slits 15. For example, as seen in FIG. 5, the first component 22 may have a wedge shape. However, it should be appreciated that the first component may have any shape or profile that may adequately fill the slits 15, as seen in FIGS. 6A-6D.

The second component 24 may be in the form of at least one sheet of material. A portion 25 of the second component 24 generally may be at or adjacent the inner diameter side of the slits 15 and therefore exposed to the melt and shielding the first component 22 from the melt. As such, the second component may a higher Curie temperature than the soft magnetic first material. The combination of the two components 22 and 24 may lower the magnetic flux density, thereby raising the permeability compared to the permeability of the second component 24 alone, as illustrated in FIGS. 7 and 8.

The first component may be made of a soft magnetic composite material that has a good saturation flux density and relative magnetic permeability, and a sufficiently high electrical resistivity to minimize eddy current generation in the insert itself. For example, the second material may have a saturation flux density of 0.2 T to 2.5 T, a relative magnetic permeability greater than 10, and an electrical resistivity greater than 0.1 Ohm-m. The first material may be, but is not limited to, Fluxtrol 100.

The second material may be made of a soft magnetic material, either solid or composite, that has a high saturation flux density, Curie temperature, relative magnetic permeability at high magnetic flux densities and field strengths, sufficiently high electrical resistivity, good corrosion resistance. For example, the second material may have a flux density of 0.5 T to 2.5 T, a magnetic permeability greater than 10, a Curie temperature of 400 degrees C. to 1200 degrees C., and an electrical resistivity of at least 0.1 μΩm. The second material may be, but is not limited to, Permendur, iron, cobalt, nickel, iron silicon alloys, iron silicon aluminum alloys, iron nickel alloys, iron cobalt alloys, and the like.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. An insert for a cold crucible, comprising:
a first component made of a soft magnetic composite material; and
a second component made of a soft magnetic material.

2. The insert of claim 1, wherein at least one of the soft magnetic material has a higher Curie temperature than the soft magnetic composite material.

3. The insert of claim 1, wherein the first component has a higher saturation flux density than the soft magnetic material.

4. The insert of claim 1, wherein the first component has a substantially wedged shape.

5. The insert of claim 1, wherein the second component includes at least one sheet of the soft magnetic material.

6. The insert of claim 1, wherein the soft magnetic material is a solid metal.

7. A cold crucible comprising:
a plurality of fingers extending in an axial direction and arranged in a circumferential direction;
a slit between adjacent fingers and extending radially from an inner diameter of the cold crucible to an outer diameter of the cold crucible; and
at least one insert in at least one slit;
wherein the at least one insert includes a first component made of a soft magnetic composite material, and a second component made of a soft magnetic component.

8. The cold crucible of claim 7, wherein at least one insert is located in at least one of a top and a bottom of the corresponding slit in an axial direction.

9. The cold crucible of claim 7, wherein only the second component is at a radial end of the slit adjacent the inner diameter of the crucible.

10. The cold crucible of claim 7, wherein at least one of:
the soft magnetic material has a higher Curie temperature than the soft magnetic composite material; and
the first component has a higher saturation flux density than the soft magnetic material.

11. The cold crucible of claim 7, wherein the first component has a substantially wedged shape.

12. The cold crucible of claim 7, wherein the second component includes at least one sheet of the soft magnetic material.

13. The cold crucible of claim 7, wherein the soft magnetic material is a solid metal.

14. A process comprising:
supplying a current through a coil wrapped around a cold crucible having a plurality of fingers extending in an axial direction and arranged in a circumferential direction;
generating a magnetic flux from the coil, which flows through slits between the fingers of the cold crucible and interacts with a charge inside the cold crucible;
passing the magnetic flux through at least one insert inserted in at least one of the slits to aid the magnetic flux to penetrate between each finger;
wherein the at least one insert includes a first component made of a soft magnetic composite material, and a second component made of a soft magnetic component.

15. The process of claim 14, wherein at least one insert is located in at least one of a top and a bottom of the corresponding slit in an axial direction.

16. The process of claim 14, wherein only the second component is at a radial end of the slit adjacent the inner diameter of the crucible.

17. The process of claim 14, wherein at least one of:
the soft magnetic material has a higher Curie temperature than the soft magnetic composite material; and
the first component has a higher saturation flux density than the soft magnetic material.

18. The process of claim 14, wherein the first component has a substantially wedged shape.

19. The process of claim 14, wherein the second component includes at least one sheet of the soft magnetic material.

20. The process of claim 14, wherein the soft magnetic material is a solid metal.
